(19) United States
(12) Patent Application Publication
(10) Pub. No.: US 2016/0117304 A1
(43) Pub. Date: Apr. 28, 2016

(54) Standalone document management method

(71) Applicant: TerraXML, Inc., Lafayette, CO (US)

(72) Inventor: Albert Francis Graham, Broomfield, CO (US)

(73) Assignee: TerraXML, Inc., Lafayette, CO (US)

(21) Appl. No.: 14/924,237

(22) Filed: Oct. 27, 2015

Related U.S. Application Data
(60) Provisional application No. 62/069,454, filed on Oct. 28, 2014.

(51) Int. Cl. G06F 17/24; H04L 29/08; H04L 12/26

(52) U.S. Cl. CPC G06F 17/243; H04L 43/0811; H04L 67/1097; H04L 67/02; H04L 67/2857

(57) ABSTRACT

A computer system includes a processor, and a network interface, coupled to the processor, for providing communication access to the computer system from a network. The computer system also includes a memory, coupled to the processor, which includes a web browser application and a disconnected mode application. The disconnected mode application provides at least one of documents and information to the web browser application. The web browser application displays the at least one of documents and information to a computer system user, and in response to the computer system user fills out a form in the web browser application, the disconnected mode application determines if there is a network connection through the network interface and in response sends the form to a network storage location through the network, if a network connection is present and stores the form to the memory, if a network connection is not present.

### CROSS REFERENCE TO RELATED APPLICATION

This application claims the benefit of U.S. Provisional Application No. 62/069,454 titled STANDALONE DOCUMENT MANAGEMENT METHOD, filed Oct. 28, 2014.

### FIELD

The present invention is directed to information management. In particular, the present invention is directed to methods for synchronizing and presenting data between a central networked database and a remote server.

### BACKGROUND

A web application is a client-server software application in which the client (or user interface) runs in a web browser. Web applications are popular due to the ubiquity of web browsers, and the convenience of using a web browser as a client to update and maintain web applications without distributing and installing software on potentially thousands of client computers is a key reason for their popularity, as is the inherent support for cross-platform compatibility. Common web applications include webmail, online retail sales, online auctions, wikis, and many other functions. Web browsers typically operate over network internet connections, and load web pages from remote computers or servers in response to directed requests from the web browser. Web applications require various software computing infrastructure such as Apache Tomcat or Java EE applications to operate independently of remote computers and network connections.

Apache Tomcat, often referred to as Tomcat, is an open-source web server and servlet container developed by the Apache Software Foundation (ASF). Tomcat implements several Java EE specifications including Java Servlet, JavaServer Pages (JSP), Java EL, and WebSocket, and provides a “pure Java” HTTP web server environment for Java code to run in. Tomcat is developed and maintained by an open community of developers under the auspices of the Apache Software Foundation, currently released under the Apache License 2.0 license, and is open-source software.

A Java EE application or a Java Platform Enterprise Edition application is any deployable unit of Java EE functionality. This can be a single Java EE module or a group of modules packaged into an Enterprise Archive (EAR) file along with a Java EE application deployment descriptor. Java EE applications are typically engineered to be distributed across multiple computing tiers. Enterprise applications can consist of combinations of Enterprise JavaBean (EJB) modules, which are packaged in JAR files, Web modules, which are packaged in WAR files, connector modules or resource adapters, which are packaged in RAR files, Session Initiation Protocol (SIP) modules, which are packaged in SAR files, application client modules, or additional JAR files containing dependent classes or other components required by the application.

An emerging strategy for application software companies is to provide web access to software previously distributed as local applications. Depending on the type of application, it may require the development of an entirely different browser-based interface, or merely adapting an existing application to use different presentation technology. These programs allow the user to pay a monthly or yearly fee for use of a software application without having to install it on a local hard drive. A company which follows this strategy is known as an application service provider (ASP), and ASPs are currently receiving much attention in the software industry.

In a cloud computing model, web applications are software as a service (SaaS). There are business applications provided as SaaS for enterprises for fixed or usage dependent fee. Other web applications are offered free of charge, often generating income from advertisements shown in web application interface.

Many businesses are enabled by open source web applications such as e-commerce software that facilitates easily creating an online retail store. Most businesses today do not need to buy data center hardware such as servers because they are affordably rented on a short term basis from a plethora of hosting companies that provide turnkey implementations of web applications. It is common for hosting providers to also offer packages of hardware and all necessary software to support the business needs of a company. Innovations in all aspects of web applications are providing tremendous economic value by increasing competition by reducing barriers to entry for new companies.

### SUMMARY

The present invention is directed to solving disadvantages of the prior art. In accordance with embodiments of the present invention, a computer system is provided. The computer system includes a processor and a network interface, coupled to the processor, for providing communication access to the computer system from a network. The computer system also includes a memory, coupled to the processor, which includes a web browser application and a disconnected mode application. The disconnected mode application provides at least one of documents and information to the web browser application. The web browser application displays the at least one of documents and information to a computer system user. In response to the computer system user fills out a form in the web browser application, the disconnected mode application determines if there is a network connection through the network interface and in response sends the form to a network storage location through the network, if a network connection is present, and stores the form to the memory, if a network connection is not present.

In accordance with other embodiments of the present invention, a computing system is provided. The computing system includes a central server, which includes a central database. The computing system also includes a remote server, which includes a disconnected mode application, a local database, and a web browser application. The computing system further includes a network, coupled to the central server and the remote server. The network allows bidirectional communication between the central database and the local database. The disconnected mode application provides documents and non-document information in the local database to the web browser application, and the web browser application displays the documents and non-document information to a computer system user. In response to the computer system user fills out a form in the web browser application, the disconnected mode application determines if there is a connection to the network and in response sends the form to the central server through the network, if a network connection is present and stores the form to a memory within the remote server, if a network connection is not present.

In accordance with still other embodiments of the present invention, a remote server for displaying documents and non-document information to a human user is provided. The remote server includes a processor, a network interface, coupled to the processor, for providing communication access to the remote server from a network, and a first memory, coupled to the processor. The first memory includes a web browser application and a disconnected mode application. A second memory physically coupled to the remote server comprises a local database, where the local database includes both non-document information and one or more documents. An initial version of the local database is loaded in the second memory prior to physically coupling the second memory to the remote server. The disconnected mode application provides both document and non-document information in the local database to the web browser application, and the web browser application displays the document and non-document information to the remote server user. In response to the remote server user fills out a form in the web browser application, the disconnected mode application determines if there is a network connection through the network interface and in response sends the form to a network storage location through the network, if a network connection is present, and stores the form to one of the first and the second memory, if a network connection is not present.

An advantage of the present invention is it provides simplified installation for non-technical users of remote servers. No complicated network setup is involved, and no knowledge of servers or system administration is required. This aids in application deployment, especially in the field where computer or IT experts may not be available.

Another advantage of the present invention is it is able to run as a web browser application regardless of the presence or absence of a network connection. Therefore, full utilization of the local database is guaranteed at all times. As long as the local database is reasonably up to date, most data and documents are available to remote server users.

Yet another advantage of the present invention is a remote server user is able to make modifications to local data, even if offline from the network. Once connection to the network is restored, the remote server automatically updates the central server with the modified data.

Yet another advantage of the present invention is it provides a common information presentation between the disconnected mode application and the server application. There is only one user interface to learn, regardless of whether the remote server is connected to the central server, or not.

Additional features and advantages of embodiments of the present invention will become more readily apparent from the following description, particularly when taken together with the accompanying drawings.

### BRIEF DESCRIPTION OF THE DRAWINGS

FIG. 1 is a block diagram illustrating a cloud storage system in accordance with embodiments of the present invention.

FIG. 2 is a block diagram illustrating remote server communication with a central database in accordance with embodiments of the present invention.

FIG. 3 is a block diagram illustrating a remote server in accordance with embodiments of the present invention.

FIG. 4 is a block diagram illustrating operation with an internet connection present in accordance with embodiments of the present invention.

FIG. 5 is a block diagram illustrating operation with an internet connection not initially present in accordance with embodiments of the present invention.

FIG. 6 is a block diagram illustrating operation with an internet connection present at a later time in accordance with embodiments of the present invention.

FIG. 7 is a flowchart illustrating file synchronization using a cloud storage process in accordance with embodiments of the present invention.

FIG. 8 is a flowchart illustrating a remote server synchronization status reporting process in accordance with the embodiments of the present invention.

FIG. 9 is a flowchart illustrating file synchronization using a message broker process in accordance the preferred embodiment of the present invention.

FIG. 10 is a diagram illustrating a disconnected mode application installation process for document distribution to a remote server in accordance with the preferred embodiment of the present invention.

FIG. 11 is a flowchart illustrating a disconnected mode installation process in accordance with the preferred embodiment of the present invention.

### DETAILED DESCRIPTION

The present inventors have observed various limitations associated with operating remote information-rich web browser applications, which the present invention overcomes. Web browsers have become ubiquitous, and synonymous with the internet. The internet has provided the dominant network over which messages (mail), video, documents, telephone audio, and even live communication sessions are conducted worldwide. Communication speeds have increased to the point that high-definition (HD) motion video and streaming audio may be transmitted via landlines, satellite, or through terrestrial wireless services including 3G, 4G, LTE, and Bluetooth.

As time goes on, various devices become increasingly complex. Cars, boats, and airplanes include many computers that perform ever more sophisticated functions. For example, cars now include computers to control engine performance, climate control, entertainment and navigation systems, and even accident avoidance and parking Home appliances include sensors and intelligence to monitor internal operation and report actual and predicted faults to service personnel (i.e. “the internet of things”, or IOT). Because of size or high transportation cost, it may not be cost effective to repair some complex items at a factory or repair depot. In many cases, it is faster and less expensive to send trained maintenance personnel to the field where the equipment is.

Complex devices typically have a very high volume of information that may be useful for field repair personnel. This information includes parts lists, schematics, assembly diagrams, service and repair manuals, troubleshooting guides, tool lists and descriptions, supplier and part location information, and test procedures. In paper form, this may easily consume many binders and manuals and the bulk/weight of such documentation may hinder the ability of field service personnel to carry the information to remote locations. Additionally, the information in paper form is generally not readily updatable in the field as new pages must be downloaded, printed, and integrated.

It is therefore desirable to provide any such required documentation and information on a portable computer that may be easily kept with field service personnel in the field. In some cases, any required documents may be stored on the portable computer itself, or on a USB stick or SD Card or other forms of temporary media. However, information that is not in document form is not easily organized or stored in this form. Also, temporary media does not include an application to automatically update the stored documents in the field.

The present invention therefore provides a series of applications and structures suitable for installation on a portable computer, or remote server, in order to provide readily updated complex information to field service or other personnel in the field. The applications and structures may be installed by any computer user, and does not depend on system administrators or other trained IT professionals to install and configure. The present invention further provides a rich user interface optimized for complex products and assemblies. The same user interface and organization is preserved for both online (i.e. internet-connected) and offline (i.e. not internet-connected or standalone) uses. The user interface supports search and display of document-level information as well as database information not stored in documents, per se.

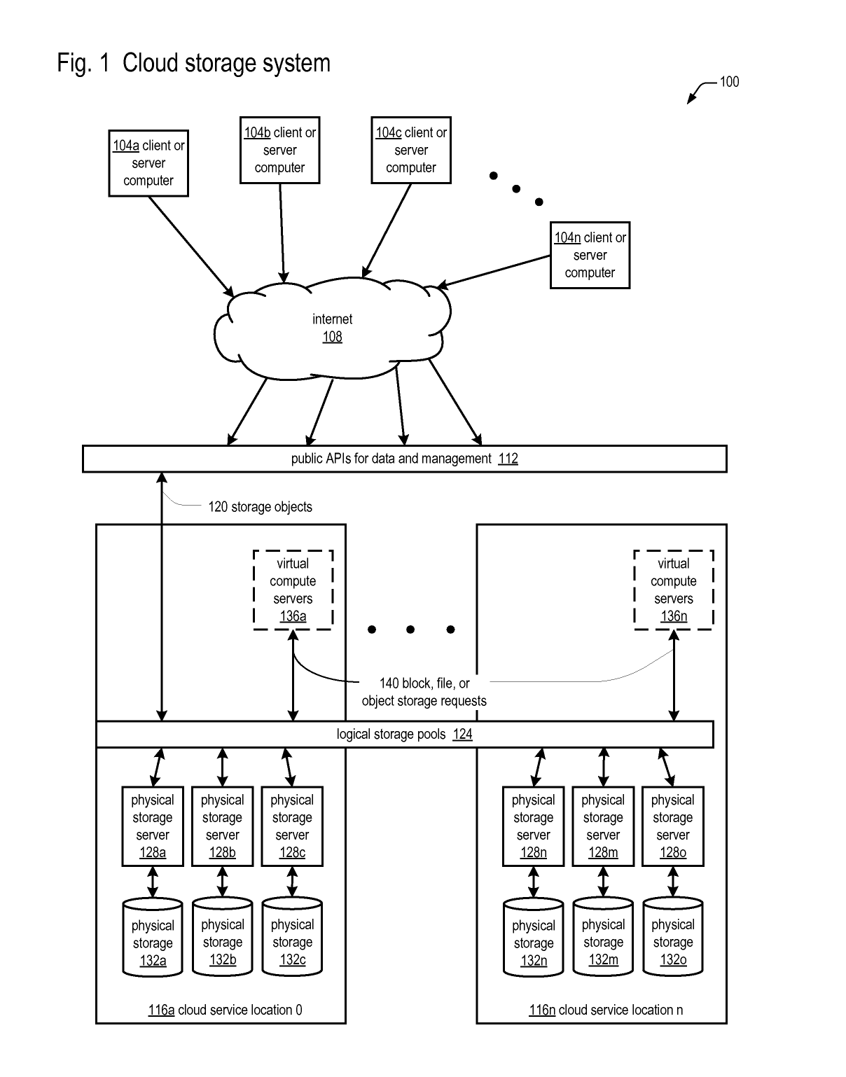

Referring now to FIG. 1, a block diagram illustrating a cloud storage system 100 in accordance with embodiments of the present invention is shown. Cloud storage is a model of internet data storage where digital data is stored in logical pools, the physical storage spans multiple servers (and often locations). Cloud storage providers are responsible for keeping the data available and accessible, and the physical environment protected and running Cloud storage services may be accessed through a co-located cloud computing service, a web service application programming interface (API), or by applications that utilize the API, such as cloud desktop storage, a cloud storage gateway, or a web-based content management system.

A cloud storage system 100 includes one or more client or server computers 104 interconnected with cloud storage resources through the internet 108. Storage requests are passed through public APIs for data and management 112. The public APIs 112 are converted into storage objects 120, which are then presented to logical storage pools 124.

A cloud storage system 100 includes one or more cloud service locations 116. FIG. 1 illustrates two cloud service locations 116, identified as cloud service location 0 116a and a cloud service location n 116n. Cloud service location 0 includes one or more physical storage servers 128, each of which controls physical storage 132. FIG. 1 illustrates three physical storage servers 128 in cloud service location 0 116a, identified as physical storage servers 128a, 128b, and 128c. Physical storage server 128a controls physical storage 132a, physical storage server 128b controls physical storage 132b, and physical storage server 128c controls physical storage 132c. Cloud service location n includes one or more physical storage servers 128, each of which controls physical storage 132. FIG. 1 illustrates three physical storage servers 128 in cloud service location n 116n, identified as physical storage servers 128n, 128m, and 1280. Physical storage server 128n controls physical storage 132n, physical storage server 128m controls physical storage 132m, and physical storage server 128o controls physical storage 132o.

Within the logical storage pools 124, block, file, or object storage requests 140 are presented to a virtual compute server 136 at each of the cloud service locations 116. Within cloud service location 0, virtual compute servers 136a process the block, file, or object storage requests 140. Within cloud service location n, virtual compute servers 136n process the block, file, or object storage requests 140.

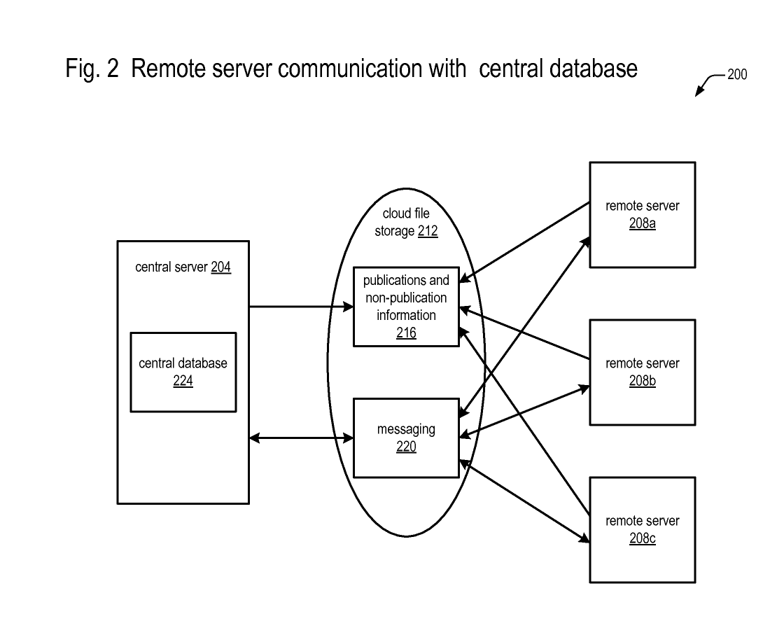

Referring now to FIG. 2, a block diagram illustrating remote server communication with a central database 200 in accordance with embodiments of the present invention is shown. A central database 224 is maintained at a central server 204, and provides centralized storage of various information required by one or more remote servers 208. The central server 204 posts publications and non-publication information 216 from the central database 224 to cloud file storage 212. Additionally, the central server 204 posts messages to each of the remote servers 208 (identified as remote server 208a, remote server 208b, and remote server 208c) through messaging infrastructure 220 within the cloud file storage 212. For example, the messaging infrastructure 220 may inform each of the remote servers 208 that a new publication or publication update 216 is available in cloud file storage 212. In response to receiving a message through the messaging infrastructure 220, each remote server 208 may retrieve one or more publications or publication updates 216 from the cloud file storage 212.

Each of the remote servers 208 operate independently of each of the other remote servers 208, and independently retrieve publications or publication updates or non-publication information 216 from the cloud file storage 212. Additionally, each remote server 208 may independently upload various forms to cloud file storage 212, and in turn, to central server 204.

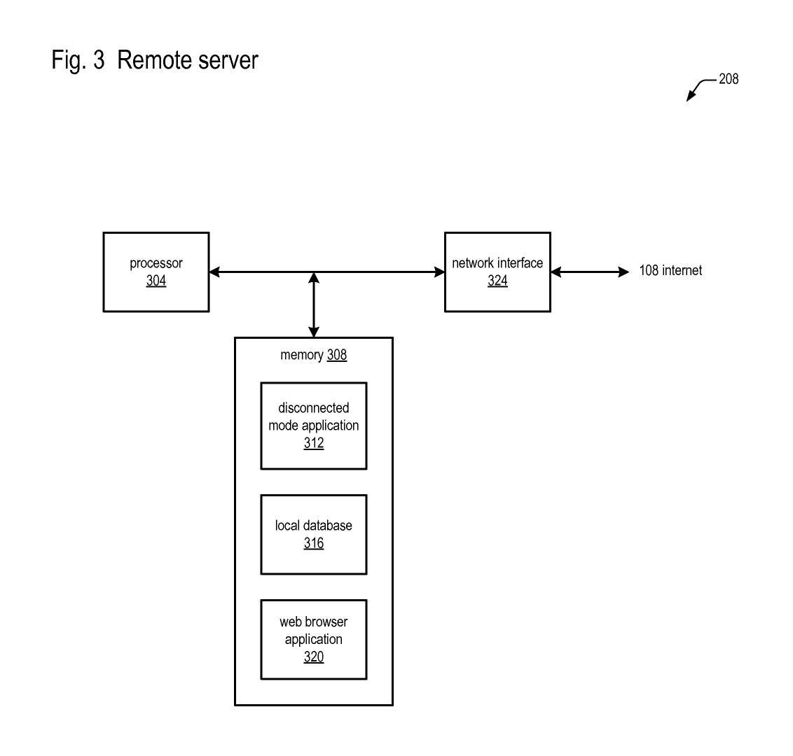

Referring now to FIG. 3, a block diagram illustrating a remote server 208 in accordance with embodiments of the present invention is shown. In the context of the present invention, remote server 208 is a computer able to retrieve and provide various information. In the preferred embodiment, remote server 208 is a portable computer including a laptop computer, tablet, or smart phone.

Remote server 208 includes a processor 304 that fetches and executes stored programs and data from memory 308. Processor 304 includes any processing device suitable for executing remote server 208 programs, such as Intel x86-compatible processors, embedded processors, mobile processors, and/or RISC processors. Processor 304 may include several devices including field-programmable gate arrays (FPGAs), memory controllers, North Bridge devices, and/or South Bridge devices.

Memory 308 may be one or more forms of volatile memory, non-volatile memory, or a combination of both volatile and non-volatile memories. The memory 308 includes firmware which includes program instructions that processor 304 fetches and executes, including program instructions for the processes of the present invention. Examples of non-volatile memory 308 include, but are not limited to, flash memory, SD, SSD, EPROM, EEPROM, hard disks, and NOVRAM. Volatile memory 308 stores various data structures and user data. Examples of volatile memory include, but are not limited to, SRAM, DDR RAM, DDR2 RAM, DDR3 RAM, Z-RAM, TTRAM, A-RAM, ETA RAM, and other forms of temporary memory.

Memory 308 includes a disconnected mode application 312, a local database 316, and a web browser application 320. The disconnected mode application 312 manages document and publication updates and informational content within local database 316. Contents of the local database 316 are viewed within the web browser application 320.

In the preferred embodiment, the local database 316 contains technical and product information suitable for field service applications. Although the value of the local database is most readily apparent when involving highly complex technical products involving many parts and assemblies, it may also be used for simple devices including relatively few parts and assemblies.

As publications, the local database 316 includes brochures, product briefs, warranty guides, maintenance manuals, schematics, parts lists, part and assembly drawings, assembly procedures, troubleshooting guides, vendor lists, and any other form of document related to a specific product or item.

As non-publication information, the local database 316 includes assembly hierarchy information (upper assemblies where used and lower assemblies), parts lists and assemblies linked by serial numbers, product identification (description and part number), customer and vendor/supplier information, and part or assembly physical locations.

In one embodiment, each of the disconnected mode application 312, local database 316, and web browser application 320 are stored in the same memory 308 of remote server 208. In other embodiments, the disconnected mode application 312, local database 316, and web browser application 320 are stored in different memories 308. For example, the disconnected mode application 312 and the web browser application 320 may be stored in a memory 308 of the portable computer or remote server 208, and the local database 316 may be stored in a USB stick, SD card, or other form of temporary memory 308 plugged into the portable computer or remote server 208. This may be of particular value where the internal memory 308 of the portable computer or remote server 208 is limited in size compared to the size of the local database 316. This may also allow, for example, an initial version of the local database 316 to be loaded from a central location, including the location where the central server 204 is located. This may be preferable if the size of the initial version of the local database 316 is extremely large and the remote server 208 does not have a high speed internet connection.

Remote server 208 also includes a network interface 324, which provides internet 108 conductivity. In the preferred embodiment, network interface 324 provides a wireless or Bluetooth connection to the internet 108. However in other embodiments, network interface 324 provides a wired Internet 108 connection. Remote server 208 is able to provide useful information through the web browser application 320 even in the event of no current internet connection 108 through the network interface 324.

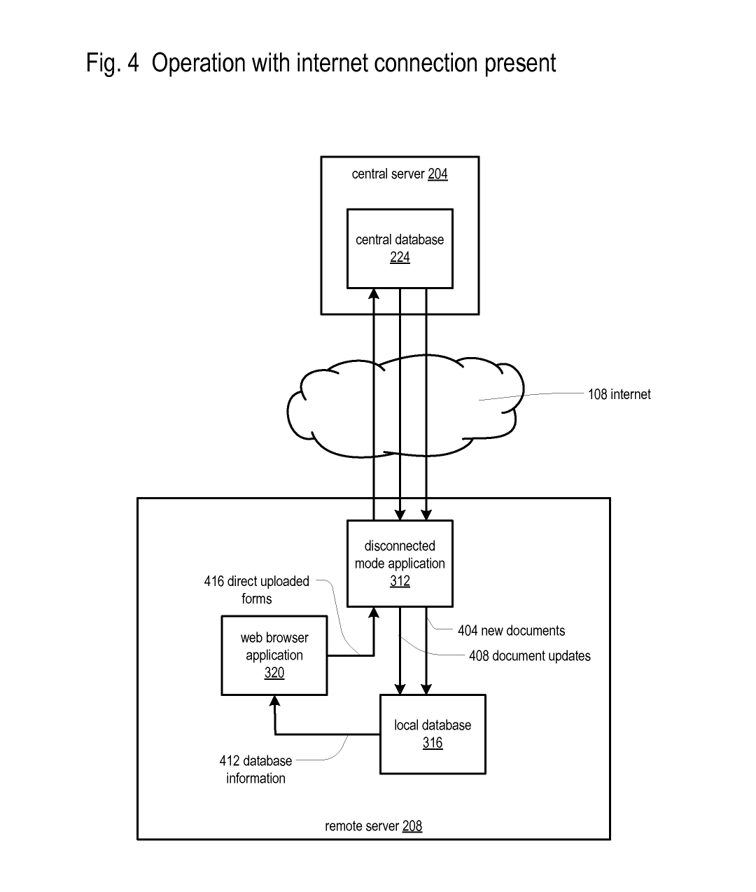

Referring now to FIG. 4, a block diagram illustrating operation with an internet 108 connection present in accordance with embodiments of the present invention is shown. When a remote server 208 is connected to a central server 204, information passes through the internet 108, which includes cloud file storage 212 (not shown for simplicity). The central server 204 includes a central database 224. The disconnected mode application 312 in the remote server 208 retrieves new documents 404 and document updates 408 from the central database 224. The new documents 404 and document updates 408 are stored in a local database 316 associated with the remote server 208.

The remote server 208 includes a web browser application 320 that displays database information 412 from the local database 316. The web browser application 320 also allows a user to fill out various forms and provide direct uploaded forms 416 through the disconnected mode application 312 to the central server 204. As long as an internet 108 connection is present, the remote server 208 operates in this fashion, and updates the local database 316 from the central database 224 as required. In the field service context, such forms may include, but are not limited to: work orders, part orders, failure analysis reports, photographs, publication update requests, action plans, status reports, or any other kind of document.

In some embodiments, the disconnected mode application 312 automatically downloads new documents or publications 404, new document updates 408, or non-document information from the central database 224 or the cloud file storage 212. In other embodiments, the disconnected mode application 312 downloads new documents or publications 404, new document updates 408, or non-document information from the central database 224 or the cloud file storage 212 only when a user directs such action through the web browser application 320. In some embodiments, the disconnected mode application 312 notifies the user through the web browser application 320 that new documents or publications 404, new document updates 408, or non-document information has been downloaded into the local database 316.

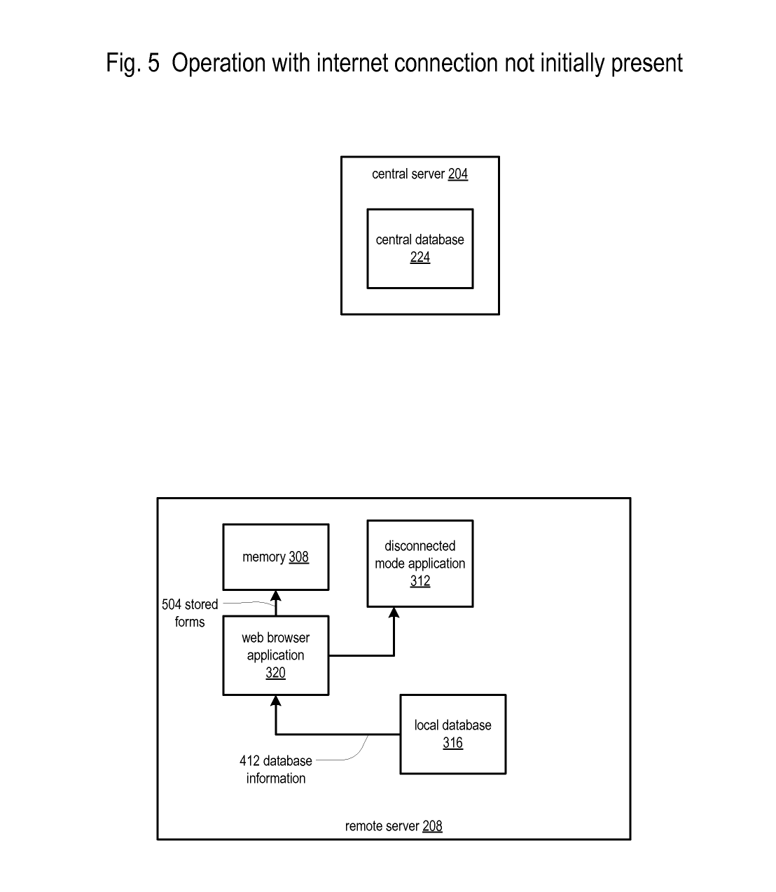

Referring now to FIG. 5, a block diagram illustrating operation with an internet 108 connection not initially present in accordance with embodiments of the present invention is shown. FIG. 5 illustrates a case when there is not currently an active internet 108 connection between the central server 204 and cloud file storage 212, in the remote server 208. In that case, the remote server 208 may not retrieve new publications or publication updates 216, or provide direct uploaded forms 416 to the central server 204 and cloud file storage 212.

The local database 316 provides database information 412 to the web browser application 320. However, when a user creates or updates forms in the web browser application 320, the forms are stored 504 in the memory 308. In this way, the remote server 208 operates autonomously from any other remote resources, including central servers 204, cloud file storage 212, and any other remote server 208.

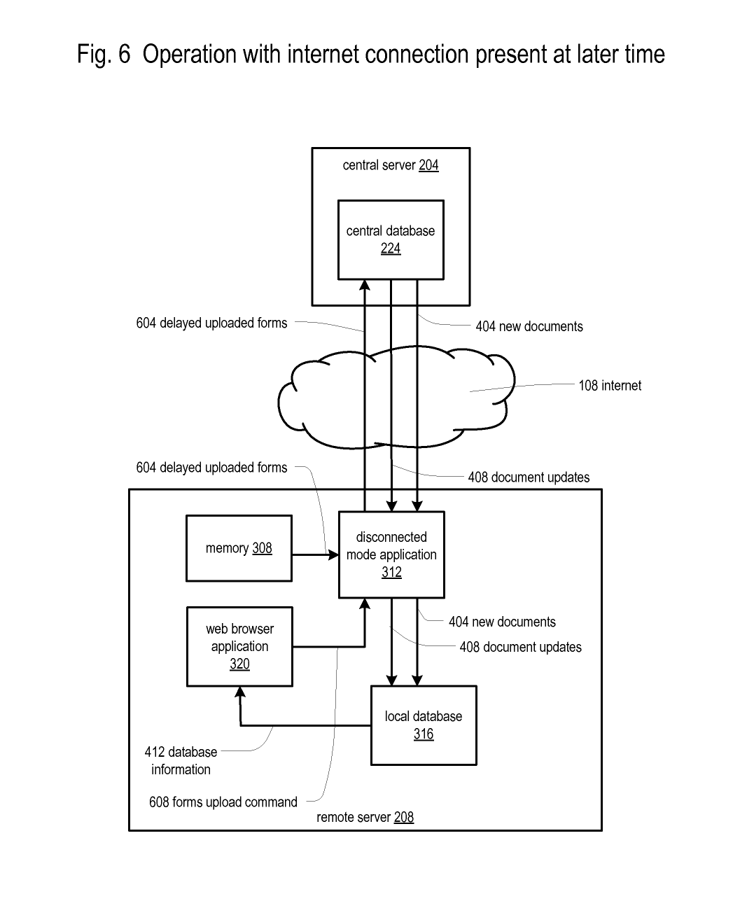

Referring now to FIG. 6, a block diagram illustrating operation with an internet 108 connection present at a later time in accordance with embodiments of the present invention is shown. FIG. 6 illustrates the sequencing of events after an internet 108 connection is restored to the remote server 208 (i.e. after FIG. 5).

After the internet 108 connection is restored, new documents 404 and document updates 408 are retrieved as required by the disconnected mode application 312, and stored in the local database 316. Database information 412 continues to be provided by the local database 316 to the web browser application 320. However, the user of the remote server 208 wishes to provide the forms stored in memory 308 to the central server 204. The web browser application 320 provides a forms upload command 608 to the disconnected mode application 312, which causes the disconnected mode application 312 to retrieve delayed uploaded forms 604 from memory 308 and provide the delayed uploaded forms 604 through the internet 108 to the central server 204. In one embodiment, the disconnected mode application 312 detects restoration of an internet 108 connection, and automatically reads the delayed uploaded forms 604 from the memory 308 before sending the delayed uploaded forms 604 to the central database 224 or cloud file storage 212. In another embodiment, the user of the web browser application 320 directs the web browser application 320 to send the forms upload command 608 to the disconnected mode application 312. This then causes the disconnected mode application 312 to read the delayed uploaded forms 604 from the memory 308 before sending the delayed uploaded forms 604 to the central database 224 or cloud file storage 212.

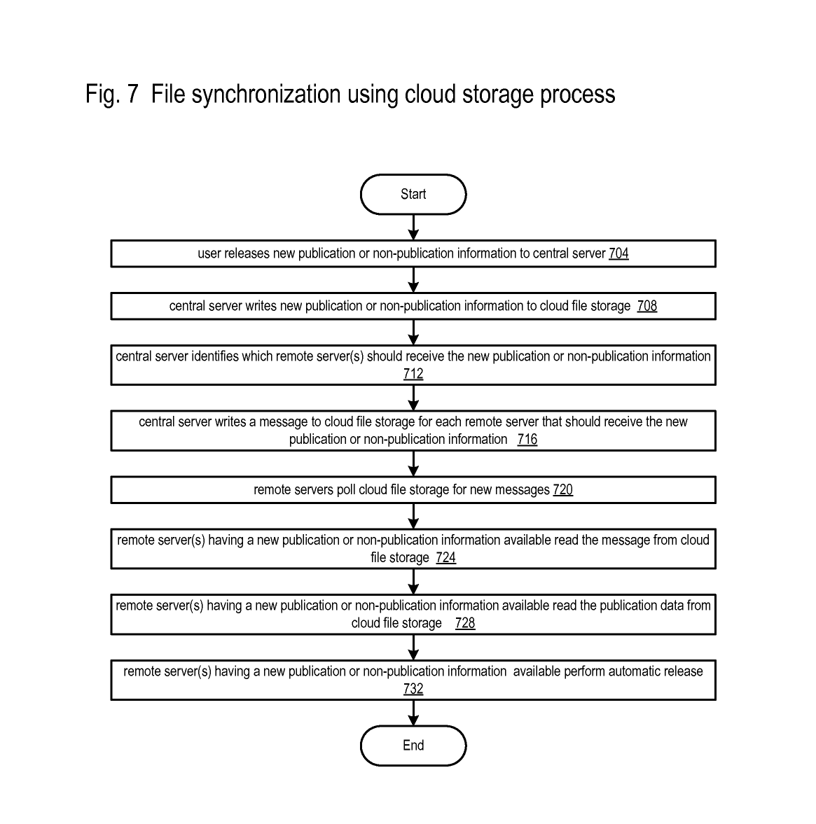

Referring now to FIG. 7, a flowchart illustrating file synchronization using a cloud file storage 212 process in accordance with embodiments of the present invention is shown. Flow begins at block 704.

At block 704, a user releases a new publication or non-publication information to the central server 204. Flow proceeds to block 708.

At block 708, the central server 204 writes new publication or non-publication information 216 to cloud file storage 212. Flow proceeds to block 712.

At block 712, the central server 204 identifies which remote server(s) 208 should receive the new publication or non-publication information 216. Flow proceeds to block 716.

At block 716, the central server 204 writes a message 220 to cloud file storage 212 for each remote server 208 that should receive the new publication or non-publication information 216. Flow proceeds to block 720.

At block 720, the remote servers 208 poll cloud file storage 212 for new messages 220. Flow proceeds to block 724.

At block 724, the remote server(s) 208 having new publication or non-publication information data 216 available read the message 220 from cloud file storage 212. Flow proceeds to block 728.

At block 728, the remote server(s) 208 having a new publication or non-publication information 216 available read the new publication or non-publication information 216 from cloud file storage 212. Flow proceeds to block 732.

At block 732, the remote server(s) 208 having a new publication or non-publication information 216 available perform automatic release. Automatic release allows all users in the system to view publications or non-publication information automatically, bypassing a review state. Flow ends at block 732.

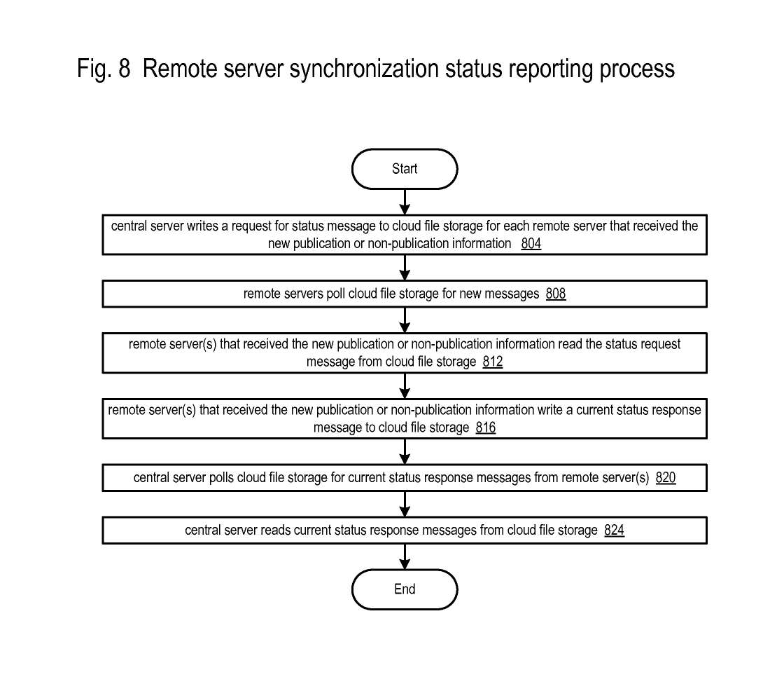

Referring now to FIG. 8, a flowchart illustrating a remote server 208 synchronization status reporting process in accordance with the embodiments of the present invention is shown. Flow begins at block 804.

At block 804, the central server 204 writes a request for status message 222 cloud file storage 212 for each remote server 208 that received the new publication or non-publication information 216. Flow proceeds to block 808.

At block 808, the remote servers 208 poll cloud file storage 212 for new messages 220. Flow proceeds to block 812.

At block 812, the remote server(s) 208 that received the new publication or non-publication information 216 read the status request message 220 from cloud file storage 212. Flow proceeds to block 816.

At block 816, the remote server(s) 208 that received the new publication or non-publication information 216 write a current status response message 222 cloud file storage 212. Flow proceeds to block 820.

At block 820, the central server 204 polls cloud file storage 212 for current status response messages 220 from remote servers 208. Flow proceeds to block 824.

At block 824, the central server 204 reads current status response messages 220 from cloud file storage 212. Flow ends at block 824.

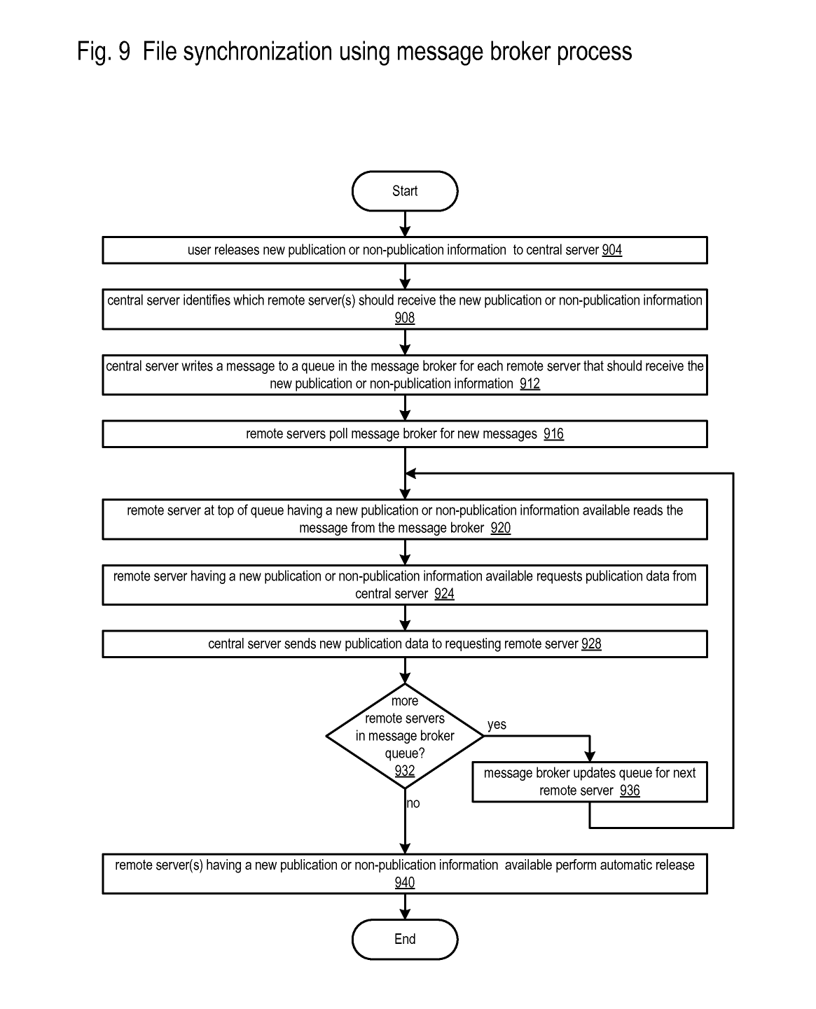

Referring now to FIG. 9, a flowchart illustrating file synchronization using a message broker process in accordance the preferred embodiment of the present invention is shown. A message broker is an intermediary program module which translates a message from the formal messaging protocol of the sender to the formal messaging protocol of the receiver. Message brokers are elements in communication networks whereby software applications communicate by exchanging formally defined messages. Message brokers advantageously minimize mutual awareness that software applications should have of each other in order to be able to exchange messages. Message brokers route messages to one or more destinations, transform messages to an alternative representation, perform message aggregation while decomposing messages into multiple messages and sending them to their destination(s) and later re-composing the responses into one message to return to the user, interact with an external repository to augment or store a message, invoke various web services to retrieve data, respond to events or errors, and provide content and topic-based message routing. Flow begins at block 904.

At block 904, a user releases a new publication or non-publication information to a central server 204. The new publication or non-publication information is stored in a central database 224. Flow proceeds to block 908.

At block 908, the central server 204 identifies which remote server(s) 208 should receive the new publication or non-publication information 216. Flow proceeds to block 912.

At block 912, the central server 204 writes a message 220 to a queue in the message broker for each remote server 208 that should receive the new publication or non-publication information 216. Flow proceeds to block 916.

At block 916, remote servers 208 poll the message broker for new messages 220. Flow proceeds to block 920.

At block 920, a remote server 208 at the top of the message broker queue having a new publication or non-publication information 216 available reads the message 220 from the message broker. Flow proceeds to block 924.

At block 924, a remote server 208 having a new publication or non-publication information 216 available request publication data from the central server 204. Flow proceeds to block 928.

At block 928, the central server 204 sends new publication data to the requesting remote server 208. Flow proceeds to decision block 932.

At decision block 932, the message broker determines in the message broker queue if there are more remote servers 208 in the message broker queue. If there are more remote servers 208 in the message broker queue, then the next remote server 208 is serviced and flow proceeds to block 936. If there are not more remote servers 208 in the message broker queue, then flow proceeds to block 940.

At block 936, the message broker updates the message broker queue for the next remote server 208. Flow proceeds to block 922 process the publication update for the next remote server 208.

At block 940, the remote server(s) 208 having a new publication or non-publication information 216 available perform automatic release. Automatic release allows all users in the system to view publications or non-publication information automatically, bypassing a review state. Flow ends at block 940.

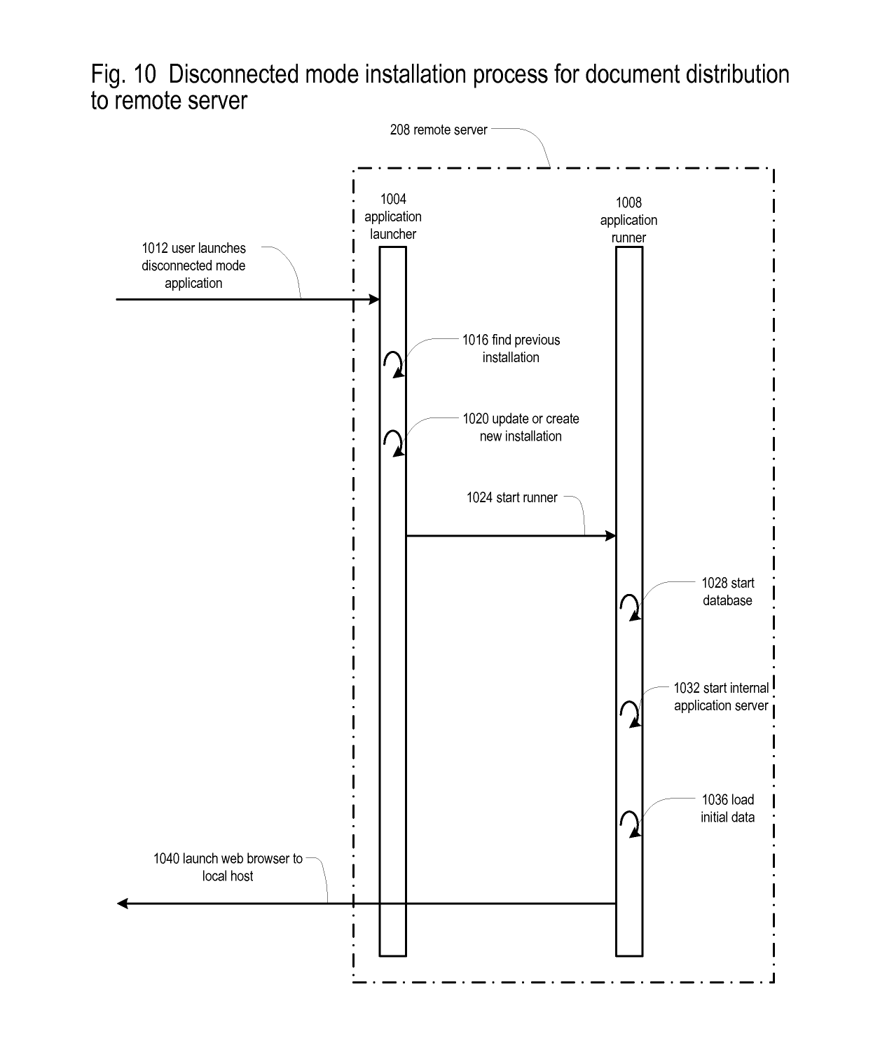

Referring now to FIG. 10, a diagram illustrating a disconnected mode application 312 installation process for document distribution to a remote server 208 in accordance with the preferred embodiment of the present invention is shown. Remote server 208 includes a disconnected mode application 312, which consists of an application launcher 1004 and an application runner 1008. An application launcher 1004 is a process within the disconnected mode application 312 that is responsible for detecting and handling previous runtimes and setting up a runtime process. The runtime process is the application runner 1008. The application runner 1008 is a process within the disconnected mode application 312 that is responsible for orchestrating sub processes creating a runtime environment for the web browser application 320 to run within.

Initially, the user of remote server 208 launches 1012 the disconnected mode application 312. The disconnected mode application 312 is stored in the memory 308 of the remote server 208, and commonly an icon representing the disconnected mode application 312 is invoked to launch the disconnected mode application 312. Next, the application launcher 1004 looks for a previous installation 1016 of the disconnected mode application 312. If a previous installation of the disconnected mode application 312 is present in the memory 308 of the remote server 208, the application launcher 1004 updates the disconnected mode application 1020. If a previous installation of the disconnected mode application 312 is not present in the memory 308 of the remote server 208, the application launcher 1004 instead creates a new installation 1020 of the disconnected mode application 312.

The application launcher 1004 then starts 1024 the application runner 1008. The application runner 1008 then starts 1028 the local database 316. The application runner 1008 then starts 1032 an internal application server, and loads 1036 initial data into the local database 316. In the preferred embodiment, the internal application server is a Java library used within the disconnected mode application 312, which is a Java application. At this point, the local database 316 is ready to be used to store information or provide information to a local web browser application 320. The application runner 1008 then launches web browser application 320 to a local host 1040. The local host 1040 is a hostname that means “this computer or this host”. For example, launching the web browser application 320 to a local host 1040 means opening the web browser application 320 to IP address 127.0.0.1.

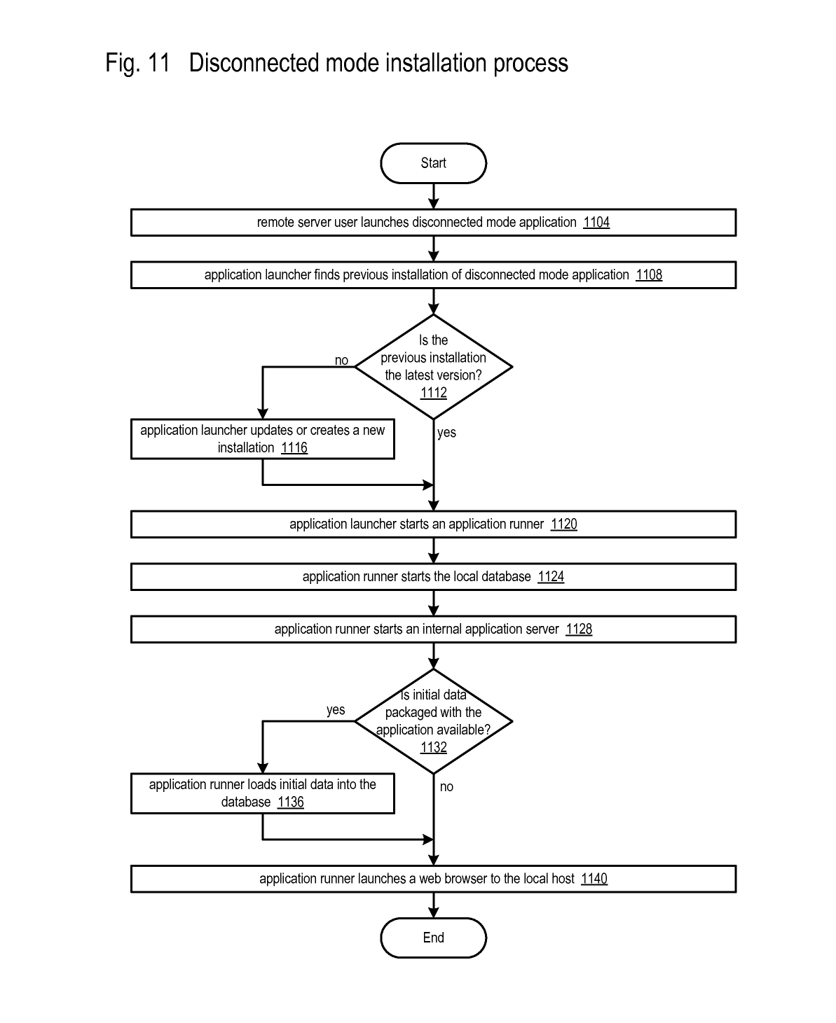

Referring now to FIG. 11, a flowchart illustrating a disconnected mode installation process in accordance with the preferred embodiment of the present invention is shown. Flow begins at block 1104.

At block 1104, a remote server 208 user launches a disconnected mode application 312. Flow proceeds to block 1108.

At block 1108, an application launcher 1004 finds a previous installation of the disconnected mode application 312. Flow proceeds to decision block 1112.

At decision block 1112, the application launcher 1004 determines if the previous installation of the disconnected mode application 312 is the latest version. If the previous installation of the disconnected mode application 312 is not the latest version, then flow proceeds to block 1116. If the previous installation of the disconnected mode application 312 Is the latest version, then flow instead proceeds to block 1120.

At block 1116, the application launcher 1004 updates or creates a new installation of the disconnected mode application 312. Flow proceeds to block 1120.

At block 1120, the application launcher 1004 starts an application runner 1008. Flow proceeds to block 1124.

At block 1124, the application runner 1008 starts the local database 316. Flow proceeds to block 1128.

At block 1128, the application runner 1008 starts an internal application server. Flow proceeds to decision block 1132.

At decision block 1132, the internal application server determines if initial data packaged with the disconnected mode application 312 is available. If initial data packaged with the disconnected mode application 312 is available, then flow proceeds to block 1136. If initial data is not packaged with the disconnected mode application 312, then flow proceeds to block 1140.

At block 1136, the application runner 1008 loads initial data into the local database 316. Flow proceeds to block 1140.

At block 1140, the application runner 1008 launches a web browser 320 to the local host. The local host is a hostname that means “this computer or this host”. For example, launching the web browser application 320 to a local host means opening the web browser application 320 to IP address 127.0.0.1. At this point, the disconnected mode application 312, local database 316, and web browser application 320 are all running Flow ends at block 1140.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. A computer system, comprising:
a processor;
a network interface, coupled to the processor, for providing communication access to the computer system from a network; and
a memory, coupled to the processor, comprising:
a web browser application; and
a disconnected mode application;
wherein the disconnected mode application provides at least one of documents and non-document information to the web browser application, wherein the web browser application displays documents and non-document information to a computer system user, wherein in response to the computer system user fills out a form in the web browser application, the disconnected mode application determines if there is a network connection through the network interface and in response:
sends the form to a network storage location through the network, if a network connection is present; and
stores the form to the memory, if a network connection is not present.

2. The computer system of claim 1, wherein the memory further comprises:
a local database, wherein the documents and non-document information are stored in the local database.

3. The computer system of claim 2, wherein the local database is stored in a separate memory from the web browser application and the disconnected mode application, wherein the separate memory may be separated from the computer system, wherein the local database is initially populated with documents and non-document information from a computer other than the computer system.

4. The computer system of claim 2, wherein the disconnected mode application populates the local database with at least one of documents and non-document information from the network storage location prior to the web browser application displays the documents and non-document information to the computer system user.

5. The computer system of claim 4, wherein the network storage location is at least one of a central database and cloud file storage, wherein a central server comprises the central database.

6. The computer system of claim 5, wherein if there is a network connection through the network interface, the disconnected mode application automatically updates the local database from at least one of the central database and the cloud file storage.

7. The computer system of claim 2, wherein after the disconnected mode application stores the form to the memory, without user intervention the disconnected mode application reads the form from the memory and sends the form to the network storage location if a network connection is present.

8. The computer system of claim 2, wherein after the disconnected mode application stores the form to the memory, a user requests the disconnected mode application through the web browser application to read the form from the memory and send the form to the network storage location if a network connection is present.

9. The computer system of claim 2, wherein the disconnected mode application determines if the disconnected mode application is a latest version, and prior to accessing the local database updates the disconnected mode application from the network storage location if the disconnected mode application is not the latest version.

10. The computer system of claim 2, wherein starting the disconnected mode application loads and displays the web browser application, if the web browser application is not already loaded, and links the web browser application to the local database.

11. A computing system, comprising:
a central server, comprising:
a central database;
a remote server, comprising:
a disconnected mode application;
a local database; and
a web browser application; and
a network, coupled to the central server and the remote server, wherein the network allows bidirectional communication between the central database and the local database,
wherein the disconnected mode application provides documents and non-document information in the local database to the web browser application, wherein the web browser application displays the documents and non-document information to a computer system user, wherein in response to the computer system user fills out a form in the web browser application, the disconnected mode application determines if there is a connection to the network and in response:
sends the form to the central server through the network, if a network connection is present; and
stores the form to a memory within the remote server, if a network connection is not present.

12. The computing system of claim 11, wherein the disconnected mode application populates the local database with documents and non-document information from the network storage location prior to the web browser application displays the documents and non-document information to the computer system user.

13. The computing system of claim 11, wherein after the disconnected mode application stores the form to the memory, the disconnected mode application automatically reads the form from the memory and sends the form to the central server if a network connection becomes present.

14. The computing system of claim 11, wherein after the disconnected mode application stores the form to the memory, a user requests the disconnected mode application to read the form from the memory and send the form to the central server if a network connection becomes present.

15. The computing system of claim 11, wherein the disconnected mode application determines if the disconnected mode application is a latest version, and updates the disconnected mode application from the central server if the disconnected mode application is not the latest version.

16. The computing system of claim 11, wherein starting the disconnected mode application loads and displays the web browser application, if the web browser application is not already loaded, and links the web browser application to the local database.

17. A remote server for displaying documents and non-document information to a human user, comprising:
a processor;
a network interface, coupled to the processor, for providing communication access to the remote server from a network; and
a first memory, coupled to the processor, comprising:
a web browser application; and
a disconnected mode application;
wherein a second memory physically coupled to the remote server comprises a local database, wherein the local database comprises both non-document information and one or more documents, wherein an initial version of the local database is loaded in the second memory prior to physically coupling the second memory to the remote server,
wherein the disconnected mode application provides both document and non-document information in the local database to the web browser application, wherein the web browser application displays the document and non-document information to the remote server user, wherein in response to the remote server user fills out a form in the web browser application, the disconnected mode application determines if there is a network connection through the network interface and in response:
sends the form to a network storage location through the network, if a network connection is present; and
stores the form to one of the first and the second memory, if a network connection is not present.

18. The remote server of claim 17, wherein if there is a network connection through the network interface, the disconnected mode application automatically updates the local database from at least one of a central database and cloud file storage.

19. The remote server of claim 18, wherein the disconnected mode application through the web browser application notifies a user that the local database has been updated.

20. The remote server of claim 19, wherein the disconnected mode application through the web browser application identifies the documents and non-document information in the local database that has been updated.
